(19) United States
(12) Patent Application Publication
(10) Pub. No.: US 2006/0095632 A1
(43) Pub. Date: May 4, 2006

(54) Data transmission coordinating method and system

(75) Inventors: Ruei-Ling Lin, Taipei (TW); Jiin Lai, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Via Technologies, Inc.

(21) Appl. No.: 11/257,259

(22) Filed: Oct. 24, 2005

(30) Foreign Application Priority Data
Nov. 2, 2004 (TW) 093133410

(51) Int. Cl. G06F 13/36

(52) U.S. Cl. 710/306

(57) ABSTRACT

In a data transmission coordinating method, information associated with a first transmission standard of the bridge chip is read from a memory unit of the computer system. A first signal from the bridge chip is issued to the central processing unit to inform the central processing unit of the first transmission standard of the bridge chip. A second signal is issued from the central processing unit to the bridge chip to inform the bridge chip of a second transmission standard of the central processing unit. A commonly operable transmission standard is coordinated for both the central processing unit and the bridge chip according to the first transmission standard and the second transmission standard.

### FIELD OF THE INVENTION

The present invention relates to a data transmission coordinating method, and more particularly to a data transmission coordinating method for use between a central processing unit and a bridge chip of a computer system.

### BACKGROUND OF THE INVENTION

A motherboard of a computer system is generally provided with a central processing unit (CPU), a chipset and some peripheral circuits. The CPU is the core component of a computer system for processing and controlling operations and cooperation of all the other components in the computer system. The chipset may be in various forms but generally includes a north bridge chip and a south bridge chip, which are used to communicate the CPU and the peripheral circuits. In general, the north bridge chip serves the communication of the high-speed buses while the south bridge chip serves the communication of low-speed devices in the computer system.

FIG. 1(a) is a schematic functional block diagram illustrating devices disposed on or coupled to a motherboard 1 in a single CPU. On the motherboard 1, a chipset 2 including a north bridge chip 20 and a south bridge chip 21 is electrically connected to the CPU 10 via a front side bus (FSB) 22. On the motherboard 1, an accelerated graphics port (AGP) interface 31 and a random access memory (RAM) 32 are electrically connected to the north bridge chip 20 via an AGP bus 311 and a memory bus 321, respectively. A peripheral component interconnect (PCI) interface 30 is electrically connected to the south bridge chip 21 via a PCI bus 301. In addition, an industry standard architecture (ISA) interface 40, an integrated device electronics (IDE) interface 41, a universal serial bus (USB) interface, an external keyboard device 43 and an external mouse device 44, which operate at a low speed, are electrically connected to the south bridge chip 21.

In the above architecture, the standard of the FSB 22 should support both the north bridge chip 20 and the CPU 10 coupled thereto, as illustrated in FIG. 1(b). If the transmission standard of the north bridge chip 20 via the FSB 22 mismatched that of the CPU 10, e.g. the bandwidth or bit speed in MHz thereof is different, the communication between the north bridge chip 20 and the CPU 10 would fail or some of transmitted data might be lost. For example, a bridge chip adapted to a processor with a 64-bit front-side-bus bandwidth will be unsuited to another processor with a 32-bit front-side-bus bandwidth. Otherwise, a half of the transmitted data will not be received. In other words, the compatibility between the CPU and the bridge chip is critical for data transmission. Therefore, various standards of bridge chips need be manufactured and stored for selection.

Some possible combinations of front-side-bus bandwidth of the CPU and the north bridge chip are exemplified with reference to FIGS. 2(a)˜2(d). The front side bus (FSB) includes an address bus and a data bus respectively for address and data transmission between the CPU and the north bridge chip. In the example of FIG. 2(a), the CPU 101 and the north bridge chip 201 have the same FSB bandwidth, i.e. 32 bits and 64 bits, respectively for both address and data transmission. Since the transmission standards of the CPU 101 and the north bridge chip 201 are compatible with each other, the system can operate normally. Likewise, in the example of FIG. 2(b), the CPU 102 and the north bridge chip 202 have the same FSB bandwidth, i.e. 13 bits and 32 bits, respectively for both address and data transmission. Since the transmission standards of the CPU 102 and the north bridge chip 202 are compatible with each other, the system can operate normally. In the example of FIG. 2(c), on the other hand, while the CPU 102 has 13-bit bandwidth for address transmission and 32-bit bandwidth for data transmission, the north bridge chip 201 has 32-bit bandwidth for address transmission and 64-bit bandwidth for data transmission. Since the transmission standards of the CPU 102 and the north bridge chip 201 are not consistent, the communication between the CPU 102 and the north bridge chip 201 cannot be normally performed. A similar idle situation is illustrated in FIG. 2(d), where the CPU 101 allowing 32-bit bandwidth for address transmission and 64-bit bandwidth for data transmission is inconsistent with the north bridge chip 201 allowing 13-bit bandwidth for address transmission and 32-bit bandwidth for data transmission.

With increasing tendency to compact size, personal mobile computing devices such as personal digital assistants (PDAs) or notebook computers require smaller chips and motherboards or lower pin numbers. In other words, it is preferred in one way that the integrated bridge chips and CPUs have reduced bandwidth, e.g. the example as shown in FIG. 2(b). Whereas, in a desktop computer system supporting various applications, a chip with a high pin number is preferred so that the CPU preferably has 128-bit FSB bandwidth or more. In addition, inconsistent transmission speeds of the CPU and bridge chip also adversely affect the communication.

It is understood from the above description that depending on applications, different transmission standards of CPUs are used for pursuing the best performance or most compact effects, and thus different transmission standards of bridge chips are required to follow the transmission standards of the corresponding CPUs. It would be adversely affect the utility of material and production.

### SUMMARY OF THE INVENTION

The present invention provides a data transmission coordinating method, which is performed in advance to coordinate an operable transmission bandwidth and speed for both the central processing unit and the bridge chip of a computer system, thereby making the usage of the central processing unit and bridge chip flexible.

The present invention provides a data transmission coordinating method for a central processing unit and a bridge chip of a computer system. In the data transmission coordinating method, information associated with a first transmission standard of the bridge chip is read from a memory unit of the computer system. A first signal from the bridge chip is issued to the central processing unit to inform the central processing unit of the first transmission standard of the bridge chip. A second signal is issued from the central processing unit to the bridge chip to inform the bridge chip of a second transmission standard of the central processing unit. A commonly operable transmission standard is coordinated for both the central processing unit and the bridge chip according to the first transmission standard and the second transmission standard.

The present invention also provides a data transmission coordinating method for a central processing unit and a bridge chip of a computer system. The method includes the following steps: entering a coordinating state of the computer system; reading information from a memory unit of the computer to realize a first maximum bit number of the bridge chip for data transmission with the central processing unit via a bus; informing the central processing unit of the first maximum bit number of the bridge chip; informing the bridge chip of a second maximum bit number of the central processing unit for data transmission with the bridge chip via the bus; coordinating a commonly operable maximum bit number for data transmission between the central processing unit and the bridge chip via the bus according to the first and second maximum bit numbers; and resetting the central processing unit to operate with the commonly operable maximum bit number.

The present invention also provides a data transmission coordinating system including a bridge chip, a central processing unit, a bus and a memory unit. The bridge chip is operable under a first transmission standard. The central processing unit is operable under a second transmission standard. The bus communicates the bridge chip and the central processing unit under an operable transmission standard common to the bridge chip and the central processing unit. The memory unit stores the information associated with the first transmission standard. The bridge chip reads the first transmission standard from the memory unit and issues a fist signal to inform the central processing unit of the first transmission standard thereof, and the central processing unit issues a second signal to inform the bridge chip of the second transmission standard thereof after a coordinating state is entered, thereby coordinating the operable transmission standard for data transmission between the bridge chip and the central processing unit via the bus according to the first transmission standard and second transmission standard.

### BRIEF DESCRIPTION OF THE DRAWINGS

The above contents of the present invention will become more readily apparent to those ordinarily skilled in the art after reviewing the following detailed description and accompanying drawings, in which:

FIG. 1(a) is a schematic circuit block diagram of a computer system;

FIG. 1(b) is a schematic diagram illustrating the data transmission between the CPU and the north bridge chip via the front side bus;

FIGS. 2(a)˜2(d) are schematic diagrams illustrating four exemplified combinations of bus transmission bandwidth of CPU and north bridge chip;

FIG. 3 is a schematic diagram illustrating a data transmission coordinating method according to an embodiment of the present invention, wherein the CPU and the north bridge chip issue respective coordinating signals via selected ones of pins disposed therebetween;

FIG. 4 is a flowchart illustrating a data transmission coordinating method according to an embodiment of the present invention;

FIGS. 5(a)˜5(d) are time sequence plots illustrating a data transmission coordinating method according to an embodiment of the present invention;

FIG. 6 is a flowchart exemplifying a data transmission coordinating method according to the embodiment of FIG. 5; and

FIG. 7 is a flowchart exemplifying a data transmission coordinating method according to the embodiment of FIG. 5.

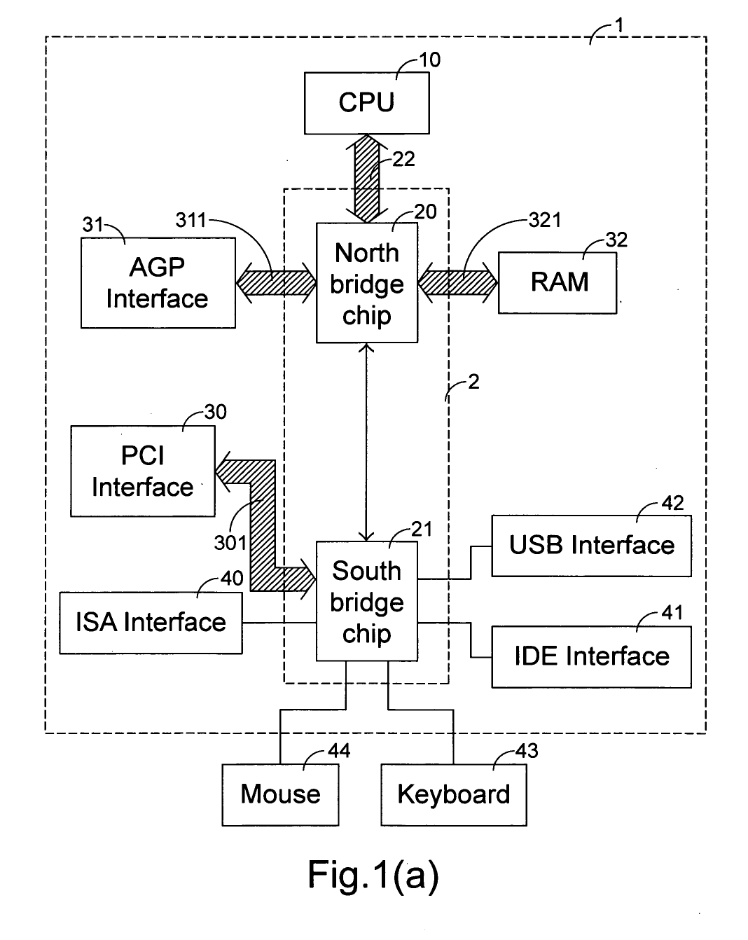

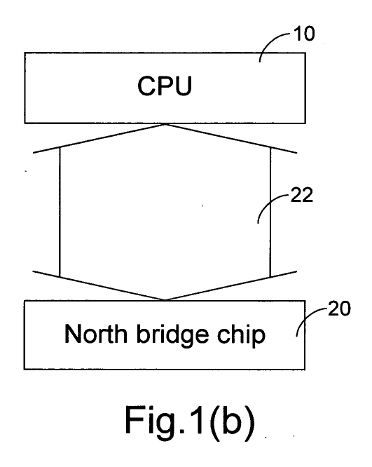

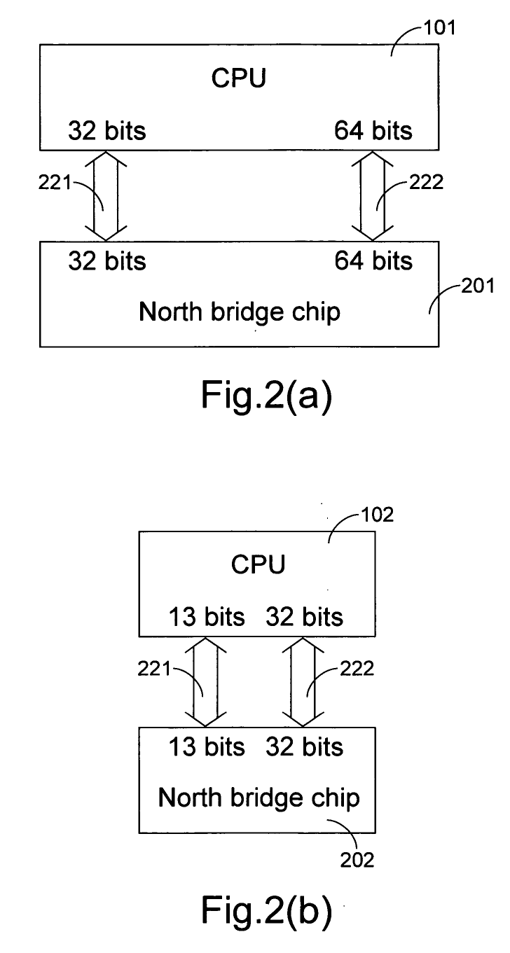

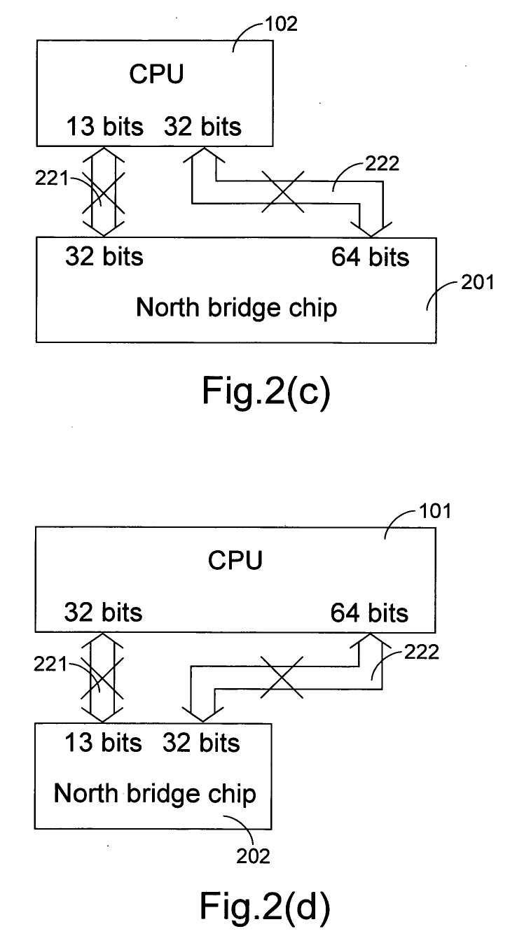

### DETAILED DESCRIPTION OF THE PREFERRED EMBODIMENT

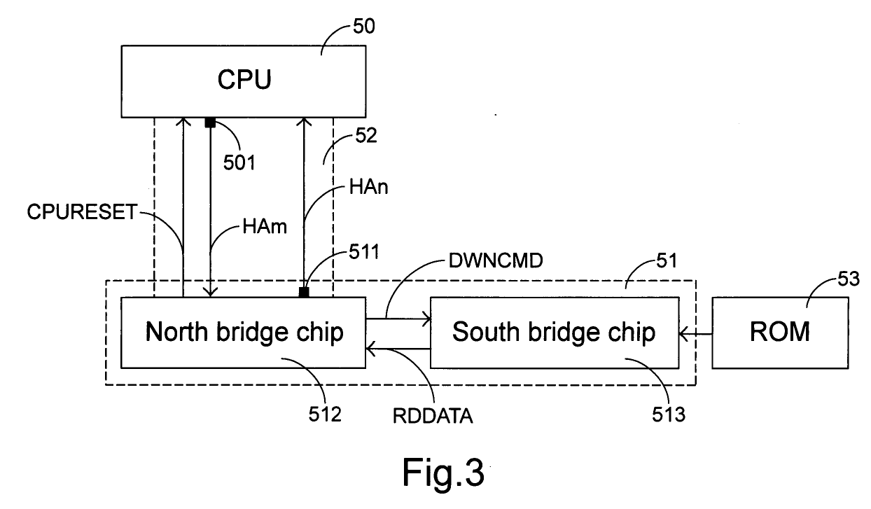

In order to enable the CPU and bridge chip with possibly inconsistent transmission standards to communicate with each other, a data transmission coordinating method according to the present invention is performed in advance to coordinate a commonly operable transmission standard for both the central processing unit and the bridge chip of a computer system. An embodiment of the data transmission coordinating method will be illustrated herein with reference to FIG. 3.

In a computer system of FIG. 3, a CPU 50 communicates with a chipset 51 that a north bridge chip 512 and a south bridge chip 513 are integrated. The north bridge chip 512 is electrically connected to the CPU 50 via a front side bus 52. The south bridge chip 513 is electrically connected to a read-only memory (ROM) 53, in which the front-side-bus transmission standard of the north bridge chip 512 is stored in the ROM 53. For coordinating a commonly operable front-side-bus transmission standard, the computer system enters a coordinating state, and both the CPU 50 and north bridge chip 512 informed each other of their operable front-side-bus transmission standards. As the operable front-side-bus transmission standard of the north bridge chip 512 is stored in the ROM 53, the north bridge chip 512 issues a reading signal DWNCMD to the ROM 53 via the south bridge chip 513 to read the operable transmission standard. Subsequently, via a data receiving signal RDDATA responding to the DWNCMD signal, the north bridge chip 512 realizes the operable front-side-bus transmission standard from the ROM 53. Accordingly, the CPU 50 issues a coordinating signal HAm from a pin 501 thereof, e.g. the mth bit, which is one of the pins in communication with the north bridge chip 512, and the north bridge chip 512 issues another coordinating signal HAn from a pin 511 of the chipset 51, e.g. the nth bit, which is one of the pins in communication with the CPU 50. Via the coordinating signal HAm, the north bridge chip 512 is informed of the operable front-side-bus transmission standard of the CPU 50. On the other hand, via the coordinating signal HAn, the CPU 50 is informed of the operable front-side-bus transmission standard of the chipset 51. Since the CPU 50 and the chipset 51 realize the transmission standard of each other, a commonly operable transmission standard can be coordinated.

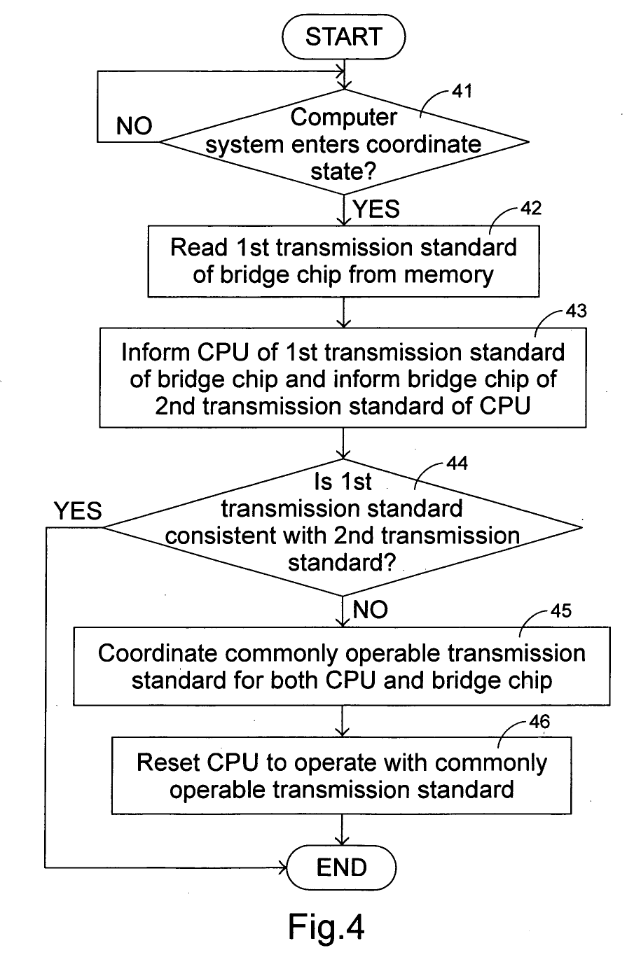

A flowchart shown in FIG. 4 illustrates a data transmission coordinating method applicable to the system of FIG. 3. For starting the data transmission coordination, a PCI reset signal is issued (Step 41). Then, the information associated with a transmission standard of the north bridge chip is read from the memory (Step 42). Then, the coordinating signals HAm and HAn are issued by the CPU and the bridge chip to each other, respectively (Step 43). If the transmission standards indicated by the coordinating signals HAm and HAn are consistent with each other (Step 44), the subsequent data transmission between the CPU and bridge chip can be performed with current transmission standards. Otherwise, a commonly operable transmission standard for both the CPU and the bridge chip is coordinated (Step 45), and then the bridge chip issues a CPU reset signal to reset the CPU (Step 46). The CPU thus operates with the commonly operable transmission standard for subsequent data transmission.

More specifically, the transmission standards are maximum bit numbers of bus transmission bandwidth or bus transmission speed. The consistency of the maximum allows the successful data transmission between the CPU and the bridge chip. For example, in a case that the coordinating signals HAm and HAn indicate 32-bit maximum bus transmission bandwidth and 32-bit maximum bus transmission bandwidth, respectively, data transmission between the CPU and the bridge chip is consistent. Likewise, in another case that the coordinating signals HAm and HAn indicate 64-bit maximum bus transmission bandwidth and 64-bit maximum bus transmission bandwidth, respectively, the consistency of the maximum allows the successful data transmission. On the other hand, if the coordinating signals HAm and HAn indicate inconsistent 64-bit and 32-bit maximum bus transmission bandwidths, a commonly operable maximum bus transmission bandwidth is necessary. As a greater bus transmission bandwidth can support a smaller bus transmission bandwidth, the smaller one of the maximum bus transmission bandwidths, i.e. 32 bits, is suitably used as the commonly operable maximum bus transmission bandwidth for data transmission between the CPU and the bridge chip.

More specifically, the coordinating signals HAm and HAn are encoded and outputted as a single bit or a serial or parallel bit combination of voltage level that differentiates the CPUs and the bridge chips, respectively. For example, when there are two choices of CPUs, e.g. 32-bit maximum bus transmission bandwidth and 64-bit maximum bus transmission bandwidth, a continuously high level and a lowered level are enough for reflecting the higher bit number and the lower bit number, which may be exchanged as well. On the other hand, bit combinations would be better for differentiating more than 2 choices of CPUs. For example, the bits “00” indicate a small bus transmission bandwidth, the bits “01” indicate a medium bus transmission bandwidth, and the bits “10” indicate a large bus transmission bandwidth.

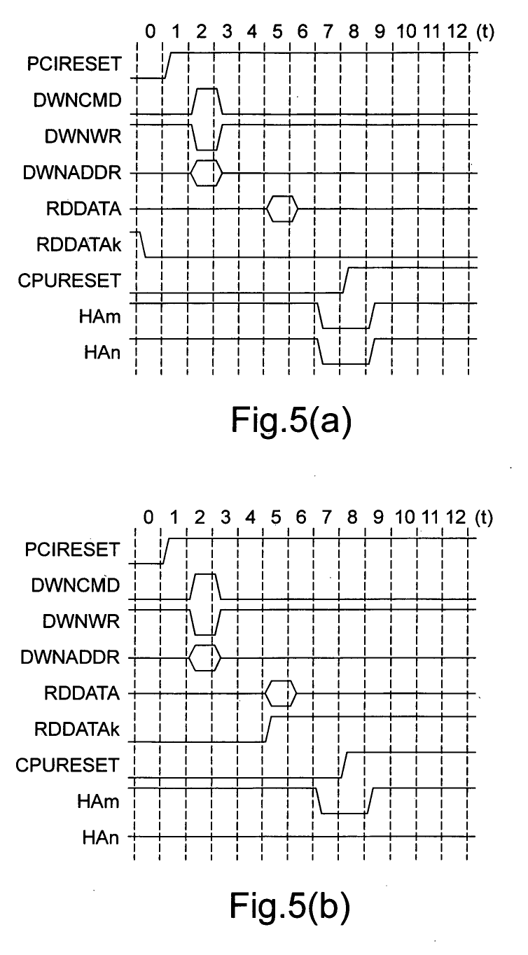

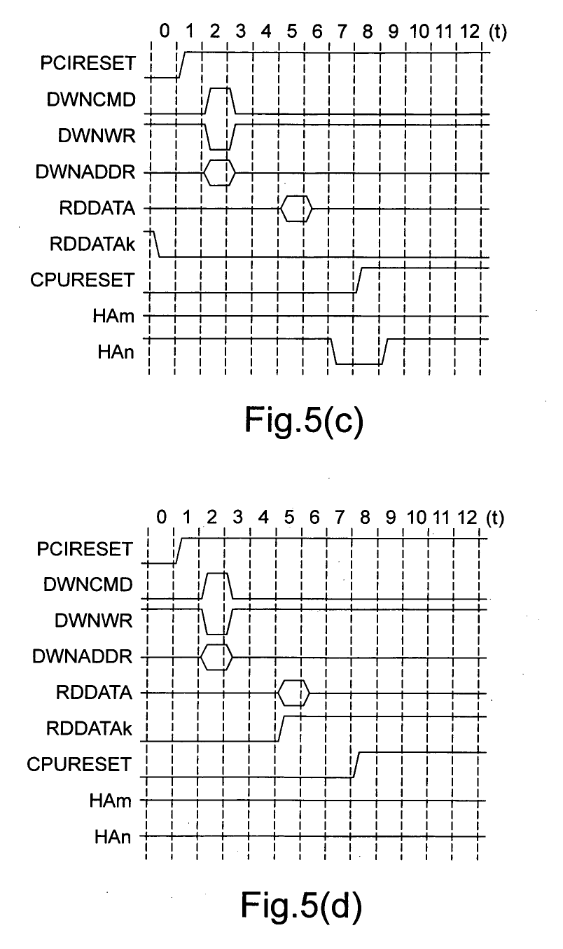

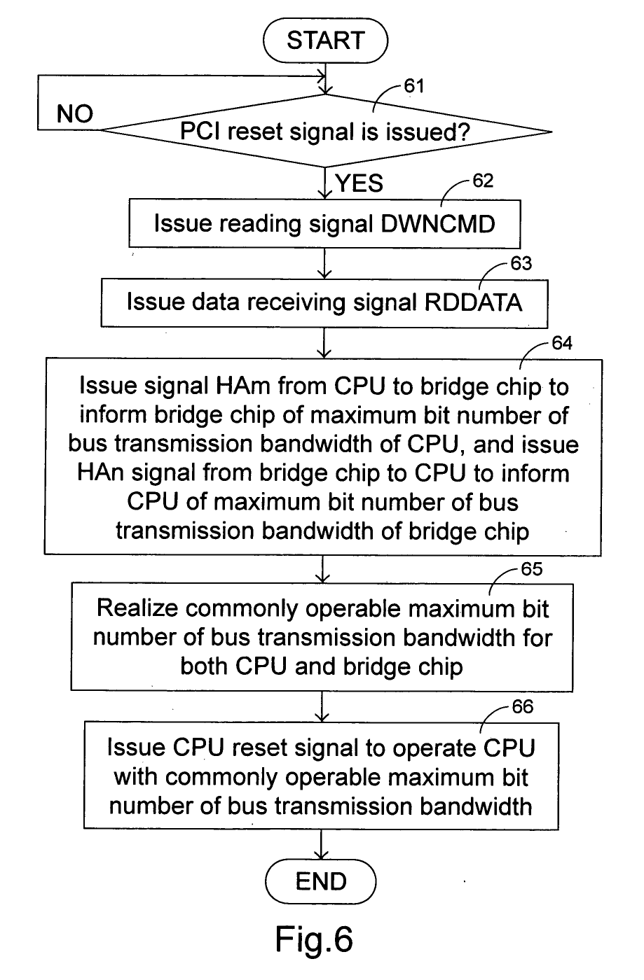

Signal-issuing time sequences of the signals involved in the present method are exemplified in FIGS. 5(a)˜5(d). As shown in FIG. 5(a), a PCI reset signal PCIRESET is first issued at t1. In response to the PCI reset signal PCIRESET, the north bridge chip 512 issues a reading signal DWNCMD, which includes two parts DWNWR and DWNADDR, to the read-only memory 53 via the south bridge chip 513 at t2. At t5, the south bridge chip 513 issues a data receiving signal RDDATA to provide the required operable transmission standard for the north bridge chip 512. The information associated with the operable transmission standard of the north bridge chip 512 is carried by a bit or a bit combination of the data receiving signal RDDATA, e.g. the kth bit, and denoted as RDDATAk. A high level state and a low level state of the signal RDDATAk reflect the larger bus transmission bandwidth and the smaller bus transmission bandwidth, respectively. In response to the data receiving signal RDDATA, a coordinating signal HAm is outputted from the CPU to the bridge chip and another coordinating signal HAn is outputted from the bridge chip to the CPU at t7. Afterwards, the CPU reset in response to the reset signal CPURESET issued by the north bridge chip will follow, e.g. at t8. As the coordinating signals HAm and HAn are both in a low level state, it means the transmission standards of the CPU and the north bridge chip is consistent with each other, so both the CPU and the north bridge chip will operate with current transmission standards for subsequent data transmission. Likewise, in FIG. 5(d), the coordinating signals HAm and HAn are both continuously high, so the reset CPU will operate with current transmission standard for subsequent data transmission with the north bridge chip. On the contrary, in FIG. 5(b) or 5(c), one of the coordinating signals HAm and Han is continuously high and the other is in a low level state, so the reset CPU will operate with a commonly operable transmission standard, for example the smaller maximum bit number of bus transmission bandwidth, for subsequent data transmission. The above examples are summarized in the flowchart of FIG. 6, Steps 61˜66.

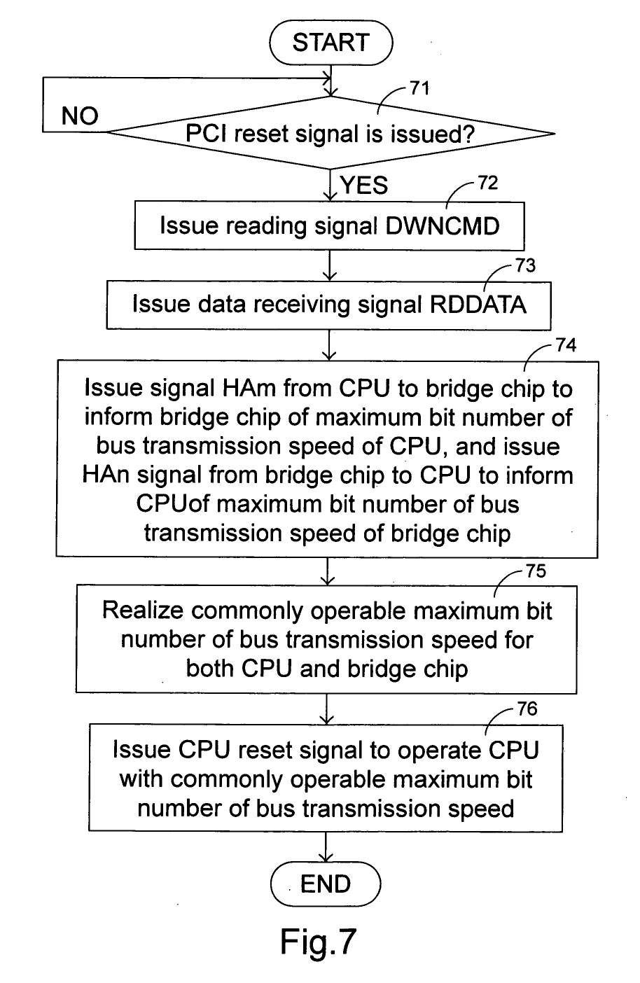

Although the above embodiments are exemplified to coordinate bus transmission bandwidth, the present invention may also be used to coordinate bus transmission speed, as described in the flowchart of FIG. 7, Steps 71˜76.

From the above embodiment, it is understood that by coordinate a commonly operable transmission standard for both the CPU and the bridge chip in advance and reset the CPU to operate with the commonly operable transmission standard, the possible incompatibility problem between the CPU and the bridge chip can be solved so that the usage of the CPU and bridge chip becomes more flexible than ever.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data transmission coordinating method for a central processing unit and a bridge chip of a computer system, comprising steps of:
reading a first transmission standard of the bridge chip from a memory unit of the computer system;
issuing a first signal from the bridge chip to the central processing unit to inform the central processing unit of the first transmission standard of the bridge chip;
issuing a second signal from the central processing unit to the bridge chip to inform the bridge chip of a second transmission standard of the central processing unit; and
coordinating a commonly operable transmission standard for both the central processing unit and the bridge chip according to the first transmission standard and the second transmission standard.

2. The method according to claim 1 wherein the information associated with the first transmission standard of the bridge chip is read after the computer system enters a coordinating state.

3. The method according to claim 2 wherein the computer system enters the coordinating state in response to a peripheral component interconnect (PCI) reset signal.

4. The method according to claim 1 further comprising a step of resetting the central processing unit to operate with the commonly operable transmission standard in response to a resetting signal.

5. The method according to claim 1 wherein the commonly operable transmission standard to be coordinated is a maximum bit number of bus transmission bandwidth.

6. The method according to claim 5 wherein the commonly operable transmission standard is the smaller one of a first maximum bit number of bus transmission bandwidth of the bridge chip and a second maximum bit number of bus transmission bandwidth of the central processing unit.

7. The method according to claim 1 wherein the commonly operable data transmission standard to be coordinated is a maximum bit number of bus transmission speed.

8. The method according to claim 7 wherein the commonly operable transmission standard is the smaller one of a maximum bit number of bus transmission speed of the central processing unit and a maximum bit number of bus transmission speed of the bridge chip.

9. The method according to claim 1 wherein the first signal is outputted by the bridge chip via a first pin communicating the bridge chip with the central processing unit.

10. The method according to claim 9 wherein the second signal is outputted by the central processing unit via a second pin communicating the central processing unit with the bridge chip.

11. The method according to claim 10 wherein the same level states of the first signal and the second signal indicate the same transmission standards, and different level states of the first signal and the second signal indicate different transmission standards.

12. The method according to claim 10 wherein the same bit combinations of the first and second signals indicate the same transmission standards, and different bit combinations of the first and second signals indicate different transmission standards.

13. The method according to claim 1 wherein the bridge chip is a north bridge chip, and the north bridge chip reads the first transmission standard from a read-only memory electrically connected to the south bridge chip of the computer system.

14. The method according to claim 13 wherein the north bridge chip issues a reading signal to read the first transmission standard, and the south bridge chip issues a data receiving signal in response to the reading signal and transmit the first transmission standard to the north bridge chip.

15. A data transmission coordinating method for use between a central processing unit and a bridge chip of a computer system, comprising steps of:
entering a coordinating state of the computer system;
reading information from a memory unit of the computer to realize a first maximum bit number of the bridge chip for data transmission with the central processing unit via a bus;
informing the central processing unit of the first maximum bit number of the bridge chip;
informing the bridge chip of a second maximum bit number of the central processing unit for data transmission with the bridge chip via the bus;
coordinating a commonly operable maximum bit number for data transmission between the central processing unit and the bridge chip via the bus according to the first and second maximum bit numbers; and
resetting the central processing unit to operate with the commonly operable maximum bit number.

16. The method according to claim 15 wherein the computer system enters the coordinating state in response to a peripheral component interconnect (PCI) reset signal.

17. The method according to claim 15 wherein the first maximum bit number, second maximum bit number and commonly operable bit number for data transmission are bit numbers of bus transmission bandwidth or bus transmission speed.

18. A data transmission coordinating system, comprising:
a bridge chip operable under a first transmission standard;
a central processing unit operable under a second transmission standard;
a bus communicating the bridge chip with the central processing unit under an operable transmission standard common to the bridge chip and the central processing unit; and
a memory unit storing the first transmission standard,
wherein the bridge chip reads the first transmission standard from the memory unit and issues a fist signal to inform the central processing unit of the first transmission standard thereof, and the central processing unit issues a second signal to inform the bridge chip of the second transmission standard thereof after a coordinating state is entered, thereby coordinating the operable transmission standard for data transmission between the bridge chip and the central processing unit via the bus according to the first transmission standard and second transmission standard.

19. The data transmission coordinating system according to claim 18 wherein the bridge chip includes:
a north bridge chip communicating with the central processing unit and issuing a reading signal to read the first transmission standard after entering the coordinating state; and
a south bridge chip electrically connected to the north bridge chip and the memory unit, issuing a data receiving signal in response to the reading signal and transmitting the first transmission standard from the memory unit to the north bridge chip.

20. The data transmission coordinating system according to claim 18 wherein the memory unit is a read-only memory, and the bus is a front-side-bus.
